(19) United States
(12) Patent Application Publication
(10) Pub. No.: US 2026/0008116 A1
(43) Pub. Date: Jan. 8, 2026

(54) Methods and Systems for Gas Tungsten Arc Welding Using Neural Networks

(71) Applicant: Electric Power Research Institute, Inc., Palo Alto, CA (US)

(72) Inventors: Shems Belhout, Nashville, TN (US); Benedikt von Querfurth, Krefeld (DE); Jonathan Tatman, Concord, NC (US); Julius Neuß, Stolberg (DE); Darren Barborak, Duluth, GA (US); Mitch Hargadine, Concord, NC (US); Will Siefert, Charlotte, NC (US)

(21) Appl. No.: 19/258,592

(22) Filed: Jul. 2, 2025

Related U.S. Application Data
(60) Provisional application No. 63/667,992, filed on Jul. 5, 2024.

(51) Int. Cl. B23K 9/095; B23K 9/173

(52) U.S. Cl. CPC B23K 9/0953; B23K 9/173

(57) ABSTRACT

In general, the present invention is directed to methods and systems for gas tungsten arc welding (“GTAW”) and, in particular, adaptive GTAW. The invention, including its various embodiments, relates to methods and systems for gas tungsten arc welding that enables autonomous, high-precision welding through a combination of predictive modeling and image-based control using neural networks. The invention is designed to operate effectively across different joint and weld geometries and includes both pre-weld planning and in-process feedback control that allows for continuous real-time adaptation throughout multi-pass welding applications, such as changes to welding variables for each pass.

### BACKGROUND OF THE INVENTION

### Field of the Invention

The invention, including its various embodiments, relates to methods and systems for gas tungsten arc welding. In particular, the invention, including its various embodiments, relates to methods and systems for gas tungsten arc welding that enables autonomous, high-precision welding through a combination of predictive modeling and image-based control using neural networks.

### Description of Related Art

A persistent challenge in the welding industry is the shortage of highly skilled labor. While traditional automated welding systems can deliver consistent results in controlled manufacturing environments, such often fail in field or construction settings where joint conditions are highly variable and less predictable. In such environments, joint geometry is affected by tolerances, fit-up issues, and other irregularities that cannot be accommodated by conventional “hard” automation systems.

Gas tungsten arc welding (GTAW) is commonly used in high-reliability applications such as nuclear component fabrication and repair. During GTAW, filler wire is introduced externally into the arc, and the success of the weld depends on maintaining an optimal entry position. Factors such as changes in wire cast, arc gap, deposition rate, and bead topography can alter the wire alignment, making continuous monitoring and correction essential. Accordingly, the process requires precise manual intervention to adjust variables and maintain consistent weld quality.

A skilled welder must not only adjust the wire position in real time but also regulate welding variables such as current, travel speed, and wire feed rate. These variables directly influence the resulting bead geometry and weld quality, and their interplay becomes increasingly complex in multi-pass welding, where the groove geometry evolves after each weld pass. Other variables, such as shielding gas composition, filler and base material composition, electrode shape and positioning, and oscillation patterns, further complicate the process.

While experienced welders can intuitively adjust for many of these factors, the complexity of some groove geometries in repair and fabrication scenarios can make manual control impractical. As such, there is a growing need for automated systems that can intelligently plan welds and adapt to changing groove profiles in real time. In particular, there is a need for automated systems that incorporate automated sensing of groove geometry, predictive modeling of weld bead formation, and closed-loop control of wire positioning and process variables. Further, there is a need for such automated systems to reduce dependency on operator experience while achieving weld outcomes comparable to those of experienced welder operators. This need is especially critical in industries such as nuclear power, where weld quality and consistency are paramount.

### BRIEF SUMMARY OF THE INVENTION

In general, the present invention is directed to methods and systems for gas tungsten arc welding (“GTAW”) and, in particular, adaptive GTAW. The invention, including its various embodiments, relates to methods and systems for gas tungsten arc welding that enables autonomous, high-precision welding through a combination of predictive modeling and image-based control using neural networks. The invention is designed to operate effectively across different joint and weld geometries and includes both pre-weld planning and in-process feedback control that allows for continuous real-time adaptation throughout multi-pass welding applications, such as changes to welding variables for each pass.

In some embodiments, the present invention is a method or process for gas tungsten arc welding comprising measuring a profile of a groove to be welded to generate data representing the groove profile; passing the data representing the groove profile and a predetermined set of welding variables to a neural network to generate a prediction of a change to the groove profile based upon the predetermine set of welding variables; generating a set of optimized welding variables based upon the prediction of the change to the groove profile for performing a weld of the groove; and autonomously welding the groove using gas tungsten arc welding using the set of optimized welding variables. In some embodiments, this method is repeated after each welding pass in a multi-pass welding process.

In another embodiment, the present invention is a method or process for gas tungsten arc welding comprising welding a groove using gas tungsten arc welding and a wire; and executing a vision-based convolutional neural network to track the wire and to control its position in real time during said welding.

In some embodiments, the present invention is a method or process for gas tungsten arc welding that includes both of the foregoing methods. For example, in some embodiments, the present invention is a method or process for gas tungsten arc welding comprising measuring a profile of a groove to be welded to generate data representing the groove profile; passing the data representing the groove profile and a predetermined set of welding variables to a neural network to generate a prediction of a change to the groove profile based upon the predetermine set of welding variables; generating a set of optimized welding variables based upon the prediction of the change to the groove profile for performing a weld of the groove; autonomously welding the groove using gas tungsten arc welding using the set of optimized welding variables; and executing a vision-based convolutional neural network to track the wire and control its position in real time during said welding.

The present invention provides an autonomous, high-precision gas tungsten arc welding process using a combination of predictive modeling and image-based control using neural networks. The invention is designed to operate effectively across different joint and weld geometries and includes both pre-weld planning and in-process feedback control that allows for continuous real-time adaptation throughout multi-pass welding applications, such as changes to welding variables for each pass. Accordingly, the invention reduces dependency on operator intervention and enables consistent, defect-free welds in constrained or variable welding environments.

### BRIEF DESCRIPTION OF THE SEVERAL VIEWS OF THE DRAWINGS

FIG. 1 is a flowchart illustrating a process of gas tungsten arc welding using a neural network to predict optimal weld deposit distribution and to provide a set of optimized welding variables tailored to the specific joint or weld profile according to one embodiment of the present invention; and

FIG. 2 is a flowchart illustrating a process of gas tungsten arc welding using image-based control and a neural network to make real-time adjustments of the wire position according to one embodiment of the present invention.

### DETAILED DESCRIPTION OF THE INVENTION

The present invention is more fully described below with reference to the accompanying drawings. While the present invention will be described in conjunction with various embodiments, such should be viewed as examples and should not be viewed as limiting or as setting forth the only embodiments of the invention. Rather, the present invention includes various embodiments and various uses, as well as alternatives, modifications, and equivalents to the foregoing, all of which are included within the spirit and scope of the invention and the claims, whether or not expressly described herein. Further, the use of the terms “invention,” “present invention,” “embodiment,” and similar terms throughout this description are used broadly and are not intended to mean that the invention requires, or is limited to, any particular embodiment or aspect being described or that such description is the only manner in which the invention may be made or used.

In general, the present invention is directed to methods and systems for gas tungsten arc welding (“GTAW”) and, in particular, adaptive GTAW. In particular, the invention, including its various embodiments, relates to methods and systems for gas tungsten arc welding that enables autonomous, high-precision welding through a combination of predictive modeling and image-based control using neural networks. The invention is designed to operate effectively across different joint and weld geometries and includes both pre-weld planning and in-process feedback control that allows for continuous real-time adaptation throughout multi-pass welding applications, such as changes to welding variables for each pass.

One component of the invention employs a sensor to measure the joint profile or weld geometry or both prior to welding or after each welding pass. These measurements and baseline welding variables, which may include arc current, arc voltage, travel speed, wire feed speed, electrode-to-work distance, hot wire current, wire stickout length, torch position and orientation in three dimensions, oscillation amplitude, frequency, dwell and if applicable shielding gas flow rate, preheat, and interpass temperature, are input into a neural network-based bead profile model that in conjunction with an optimization engine predicts optimal weld deposit distribution and outputs a set of optimized welding variables (based on user-defined constraints from the baseline variables) to the welding control system tailored to the specific joint or weld profile. The welding system then performs the weld using these optimized variables. The process can then be repeated for each welding pass in a multi-pass welding process.

A second component of the invention employs a camera to monitor the welding process in real-time and uses a neural network capable of semantic segmentation to identify and track key features of the weld process including the wire feed position, tungsten position, groove or joint, and molten weld pool geometry. From this data, the orientation and spatial offset of the wire relative to the target path can be determined. A real-time control algorithm module continuously calculates the X-Y offset from the desired wire X-Y position and issues corrective commands to a motorized wire nozzle system, adjusting X-Y placement to maintain proper alignment relative to the molten weld pool. This feedback control loop operates in parallel with the welding control system, ensuring stable wire delivery despite wire cast, helix variations, or geometric disturbances in the groove.

It should be appreciated that these two components may be used together to form an integrated, adaptive control architecture that predicts optimal welding variables, continuously monitors welding conditions, and dynamically adjusts welding variables and wire placement. As a result, invention reduces dependency on operator intervention and enables consistent, defect-free welds in constrained or variable welding environments. Each of these components is described in more detail below in connection with the accompanying Figures.

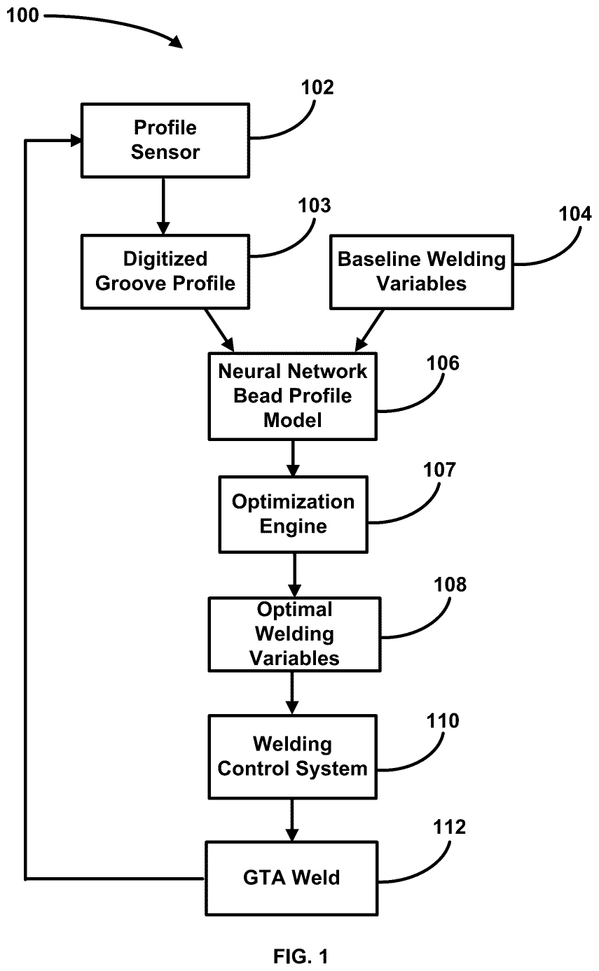

FIG. 1 is a flowchart illustrating a process of gas tungsten arc welding using a neural network to predict optimal weld deposit distribution and to provide a set of optimized welding variables tailored to the specific joint or weld profile according to one embodiment of the present invention. The process 100 begins with the collection of detailed measurements of the joint or weld geometry using a sensor 102, such as a profile sensor, that provides a set of profile sensor data. Depending on the embodiment, the sensor may be implemented as a laser profilometer, a structured light scanner, a stereo camera system, a time-of-flight sensor, an interferometric measurement device, a photogrammetry system, or a contact-based profilometry device. It should be appreciated that the collection of the profile sensor data by the sensor 102 is performed prior to welding each pass in those embodiments in which the welding process includes multiple passes.

The profile sensor data collected by the sensor 102 is digitized to generate a two-dimensional or three-dimensional profile 103 that represents features such as root opening, groove width, groove depth, joint mismatch, bevel angles, land width, and compound joint designs. It should be appreciated that many commercially available sensors may provide certain data processing functions to provide the digitized profile. As described below, these measurements are used to inform weld plan generation and are updated on a pass-by-pass basis for multi-pass weld applications.

In addition, baseline welding variables 104, which may include arc current, arc voltage, travel speed, wire feed speed, electrode-to-work distance, hot wire current, wire stickout length, torch position and orientation in three dimensions, oscillation amplitude, frequency, and dwell and if applicable, shielding gas flow rate, preheat, and/or interpass temperature, are typically predetermined or programmed by the welder or operator prior to the start of welding. and may include settings from a qualified welding procedure.

The baseline welding variables 104 and the digitized groove profile 103 are input into a neural network-based bead profile model 106 that basically predicts the effect a welding pass has on a given groove geometry for a given set of welding variables. This information is then passed to an optimization engine 107 that generates a recommended weld plan or set of optimized welding variables 108, which may be based on user-defined limits from the baseline welding variables 104. The optimized welding variables 108 are tailored to the specific joint or weld profile to be welded.

The network-based bead profile model 106 may be any neural network model that is trained to output an optimized bead shape and corresponding set of optimal welding variables, which may include arc current, arc voltage, travel speed, wire feed speed, electrode-to-work distance, torch position, travel and work angle, oscillation amplitude, dwell, and frequency if applicable, shielding gas flow rate, and preheat or interpass temperature. The neural network model may be configured with one or more hidden layers consisting of any number of nodes and trained using prior weld data collected for a range of groove geometries and welding conditions. In one embodiment, the neural network model can encode a given groove geometry using convolutional layers and a set of welding parameters, such as those listed above, using fully connected layers. The neural network combines the encodings of the groove geometry and gas tungsten arc welding parameters using a variable number of hidden layers. The model is trained to predict how a groove profile changes based on a beforehand profile scan and a set of welding parameters. As training data prior weld data collected for a range of groove geometries, welding conditions and parameter sets are used. It should be appreciated that typically the number of nodes to the artificial neural network input layer is determined by the number of input variables, and the number of nodes to the artificial neural network output layer is determined by the number of output variables. The number of hidden layers and their number of nodes are pre-determined by the programmer setting up the artificial neural network.

An optimization engine 107 utilizes the prediction of the effect a welding pass on the current groove geometry from the neural network model 106 to generate the set of optimized welding variables 108. This optimization engine 107 can evaluate a range of feasible variable combinations and eliminate any that exceed process limits such as maximum weld heat input. The resulting variable set is selected to promote an optimized weld profile and adequate fill given the digitized grove profile condition. This requires defining a loss function that can numerically describe the quality of a resulting weld geometry. The optimization engine can then evaluate the combination of welding parameters by either evaluating all possible combinations against the neural network and the loss function using brute force, or by using a search algorithm to achieve the desired result more effectively. The parameter sets are evaluated for a variable number of points along the groove to be welded.

The optimized welding variables 108 are provided to the welding control system 110 that controls the gas tungsten arc welding equipment and, in turn, performs the gas tungsten arc weld on the given workpiece. It should be appreciated that after each welding pass, additional profile sensor data may be collected by the profile sensor 102 and the process 100 repeated. In some embodiments, the additional profile sensor data may be collected after each welding pass to provide an updated weld profile geometry, and the process 100 may then be repeated after each welding pass. In this case, a new set of optimized welding variables 108 are prepared and used by the welding control system 110 for each welding pass.

The neural network model 106 accounts for total groove volume, expected bead deposit volume per pass, maximum and minimum weld overlap between adjacent passes, and any remaining unfilled groove volume after previous weld passes. The process 100 automatically differentiates between fill passes and cap passes based on the geometry of the groove and the remaining volume to be filled for a given weld geometry. This enables consistent coverage and weld crown formation without requiring operator intervention or manual pass sequencing. Accordingly, again, after each pass, the process 100 can be repeated, noting that in some embodiments, the welding variables being input to the neural network model 106 are those used in the last welding pass in a multi-pass process.

It should be appreciated that the process 100 may be implemented using a sensor to provide a set of profile sensor data as described above. Also as described above, the sensor data is digitized by either the sensor or an appropriate computer processor. The neural network 106 may be operated by a computer and associated processor electrically connected to receive the digitized groove profile 103 and the baseline welding variables and to output the optimal welding variables 108 to the welding control system 110, which may be operated by a separate computer processor connected to the processor for the neural network 106. As described above, the actual welding is perform by GTAW equipment controlled by the welding control system 110.

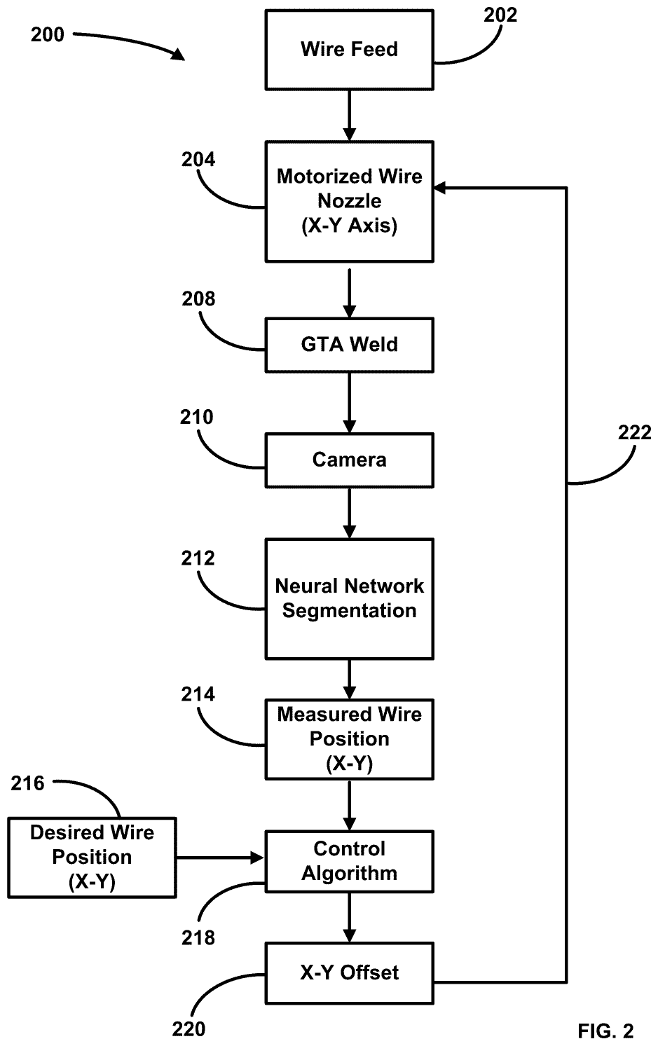

FIG. 2 is a flowchart illustrating a process of gas tungsten arc welding using image-based control and a neural network to make real-time adjustments of the wire position according to one embodiment of the present invention. During the welding process 200, a wire feed 202, including its wire cast and helix, is provided to a motorized wire nozzle 204 that feeds the wire into the active weld region. Accordingly, the gas tungsten arc welding equipment then performs the gas tungsten arc welding 208.

A camera system 210 captures live images or a video stream of the active weld region. The camera system or vision hardware may include area scan or line scan imaging sensor technology that may include optical/digital filtering to sense in the ultraviolet/visible/infrared spectrum. Images from the camera system 210 are provided to a convolutional neural network 212 that utilizes segmentation. The convolutional neural network 212 performs segmentation on the live images or video stream to identify and label relevant features in the image, such as the filler wire, tungsten electrode, molten weld pool, and groove sidewalls. From this data, the spatial relationships that include the lateral offset of the wire tip relative to the electrode centerline, the contact tip-to-work distance, the size and shape of the groove, and the size and shape of the weld pool are calculated.

In one embodiment, the segmentation is semantic segmentation. It should be appreciated that semantic segmentation is the process of labeling each pixel in an image with a specific category or class. Instead of simply recognizing the presence of an object, it accurately defines the boundaries and shapes of different objects and regions within the image. This creates a segmentation map where each pixel corresponds to a particular class (e.g., “weld pool,” “tungsten electrode,” “wire”). It should also be appreciated that a user can either setup the neural network from scratch or, alternatively, use a pretrained network to process images and assign labels to pixels, identifying regions belonging to specific classes.

It should be appreciated that based on the sematic masks predicted by the neural network, geometric features relating to the lateral offset of the wire tip relative to the electrode centerline, the contact tip-to-work distance, the size and shape of the groove, and the size and shape of the weld pool are calculated. These values are then used inside a closed-loop control algorithm to actively adjust the wire position in relation to the tungsten electrode. The relative arrangement to be achieved is determined in advance.

The desired wire X-Y position 216, or the optimal location for the wire tip to enter the weld pool, is compared to the measured wire X-Y position 214 observed by the camera. A control algorithm 218 uses a feedback controller to calculate the required correction or X-Y offset 220 that is needed to maintain the desired wire X-Y position 216. This offset 220 is transmitted to the motorized wire nozzle 204 to adjust the wire position along at least the X and Y axes.

In one embodiment, the controller is implemented using a bang-bang control algorithm with a deadband, which applies discrete correction commands when the wire deviates beyond a specified tolerance band. This style of control is effective for maintaining alignment with minimal computational overhead and is well suited to applications with moderate correction rates. In other embodiments, the controller may use more advanced control algorithms such as a proportional-integral-derivative (PID) algorithm or a model-based control algorithm, which can provide smoother or more continuous correction behavior. These alternative control methods may be beneficial in applications where finer control resolution, adaptive response, or overshoot mitigation are desired. The wire tip correction commands may be constrained by rate limits or positional bounds to ensure mechanical stability and avoid oscillatory motion. Control system variables may be tuned based on weld geometry, actuation latency, or responsiveness requirements of the motion system. Accordingly, it should be appreciated that the process 200 can be operated during and throughout the entire welding process, including during each pass in a multi-pass welding process.

It should be appreciated that the processes of both FIG. 1 and FIG. 2 can be used concurrently for the performance of a weld using GTAW. In this case, the entire adaptive system is coordinated by a central control interface that manages joint and weld data acquisition, weld plan generation, camera and profiler sensor timing, real-time vision processing, motion commands, and welding system output. The control system may operate on an embedded real-time controller, an industrial PC, or another integrated platform. It interfaces with the GTAW power supply, wire feeder, motion controller, and data logging systems. The operator may review or approve weld plans prior to execution or allow the system to function autonomously, depending on the deployment setting. Weld variables, camera imaging data, and correction metrics can be recorded for quality assurance and traceability purposes. It should be appreciated, however, that each process of FIG. 1 and FIG. 2 are operated independently of each other but can be run in parallel, noting that the actual GTA weld is performed with input from both processes of FIGS. 1 and 2.

Various embodiments of the invention have been described. However, it should be appreciated that other embodiments of the invention may be used. For example, each of the above components, the predictive modeling and image-based components, may be used separately. Further, the same components and their control for a welding process may be applied to gas metal arc welding (GMAW), additive manufacturing (direct-energy deposition or powder bed fusion), or other arc and non-arc welding processes (e.g., laser beam welding, electron beam welding) using filler wire. It should also be appreciated that the invention supports single-pass or multi-pass applications and can be configured for joint root, fill, and cap pass planning. Other embodiments are also included that would be encompassed by the above description and the following claims.

What is claimed is:

1. A method for gas tungsten arc welding, comprising:
measuring a profile of a groove to be welded to generate data representing the groove profile;
passing the data representing the groove profile and a predetermined set of welding variables to a neural network to generate a prediction of a change to the groove profile based upon the predetermine set of welding variables;
generating a set of optimized welding variables based upon the prediction of the change to the groove profile for performing a weld of the groove; and
autonomously welding the groove using gas tungsten arc welding using the set of optimized welding variables.

2. The method of claim 1, further comprising:
repeating said measuring to provide updated data representing the groove profile after said autonomous welding;
repeating said passing using the updated data representing the groove profile and the optimized welding variables to generate an updated prediction of the groove profile;
repeating said generating using the updated prediction of the groove profile to generate an updated set of optimized welding variables; and
repeating said autonomously welding using said updated set of optimized welding variables.

3. A method for gas tungsten arc welding, comprising:
welding a groove using gas tungsten arc welding and a wire; and
executing a vision-based convolutional neural network to track the wire and to control its position in real time during said welding.

4. A method for gas tungsten arc welding, comprising:
measuring a profile of a groove to be welded to generate data representing the groove profile;
passing the data representing the groove profile and a predetermined set of welding variables to a neural network to generate a prediction of a change to the groove profile based upon the predetermine set of welding variables;
generating a set of optimized welding variables based upon the prediction of the change to the groove profile for performing a weld of the groove;
autonomously welding the groove using gas tungsten arc welding using the set of optimized welding variables; and
executing a vision-based convolutional neural network to track the wire and control its position in real time during said welding.
